(19) United States
(12) Patent Application Publication
(10) Pub. No.: US 2010/0055559 A1
(43) Pub. Date: Mar. 4, 2010

(54) BATTERY AND METHOD FOR PRODUCING SAME

(75) Inventors: Toshimitsu Hirai, Hokuto (JP); Yasushi Takano, Matsumoto (JP); Kohei Ishida, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/546,722

(22) Filed: Aug. 25, 2009

(30) Foreign Application Priority Data
Aug. 26, 2008 (JP) 2008-216284

(51) Int. Cl. H01M 6/12; H01M 4/82

(52) U.S. Cl. 429/162; 29/623.1

(57) ABSTRACT

A battery includes a base member and a plurality of films arranged adjacent to each other on a same surface of the base member, at least a part of one of the films being overlapped with an adjacent one of the films.

### BACKGROUND

1. Technical Field

The present invention relates to a battery and a method for producing the battery, and particularly relates to a battery including a plurality of electrolyte films arranged on a same surface.

2. Related Art

Mobile electronic appliances and electric automobiles include a secondary battery as a power source. JP-A-2005-174617 discloses a compact, high-output secondary battery and a method for producing the same. The disclosed battery is a bipolar battery including a plurality of linearly-formed charging/discharging reaction sections arranged on an insulating member. Each of the charging/discharging reaction sections includes an electrode film, a positive electrode active material film, a solid electrolyte film, a negative electrode active material film, and an electrode film. Those films are linearly formed and arranged in an order mentioned above. Hereinafter, each electrode film, each active material film, and the solid electrolyte film, respectively, are referred to as the current collector film, the electrolyte film, and the intermediate electrolyte film, respectively.

The charging/discharging reaction section is produced by using an inkjet method. First, there is prepared each ink containing a material of each film. Then, the ink is ejected and applied on the insulating member. After drying the applied ink, a process such as polymerization is performed to form the film.

As described above, on the insulating member are arranged the current collector films, the electrolyte films, and the intermediate electrolyte film. Among the films, ends of adjacent films are in contact with each other. Upon charging and discharging, an electron and an ionized substance move between the films. In this case, the electron and the ionized substance pass through a contact surface between the films in contact with each other. However, due to a change in a film structure at the contact surface as a border between the films, the electron and the ionized substance cannot easily pass through the contact surface. In addition, when the films are thin, an area of the contact surface between the adjacent films is small, which also makes it difficult for the electron and the ionized substance to pass through the surface. Accordingly, demand has been growing for a battery that allows an electron and an ionized substance to easily move between a plurality of films to exhibit good performance of charging and discharging.

### SUMMARY

An advantage of the invention is to provide a battery that can facilitate movement of an electron and an ionized substance to improve performance of charging and discharging. Another advantage of the invention is to provide a method for producing the battery.

A battery according to a first aspect of the invention includes a base member and a plurality of films arranged adjacent to each other on a same surface of the base member, at least a part of one of the films being overlapped with an adjacent one of the films.

The battery includes the films arranged on the base member. The battery is charged and discharged by movement of an electron and an ionized substance in the films. Since the plural films are arranged, the electron and the ionized substance move between the films. In this case, when a contact area between adjacent films is largely formed, the electron and the ionized substance can more easily move between the films, as compared to forming a small contact area therebetween. In order to increase the contact area between the films, it is more effective to arrange the films in such a manner that ends of the adjacent films are overlapped with each other, rather than allowing the ends of the films to contact with each other. This can facilitate the movement of the electron and the ionized substance between the adjacent films.

Preferably, in the battery, the films include a current collector film and an electrolyte film, the current collector film being arranged adjacent to the electrolyte film in such a manner that at least a part of one of the current collector film and the electrolyte film adjacent to each other is overlapped with at least a part of an other one of the adjacent films.

In the battery, the current collector film and the electrolyte film adjacent are at least partially overlapped with each other. The current collector film supplies or collects an electron to or from the electrolyte film to allow electron movement. Additionally, due to the at least partial overlapping between the current collector film and the electrolyte film, the contact area between the current collector film and the electrolyte film are largely formed. This can facilitate electron movement between the films.

Preferably, in the battery, the electrolyte film is overlapped on the current collector film.

In the battery, the films are arranged such that the electrolyte film can be formed after forming the current collector film. In general, a current collector film is made of a highly conductive material and thus is often made of metal. In that case, the current collector film is formed by applying and burning metal microparticles. If the current collector film is formed after arranging the electrolyte film, the electrolyte film can be damaged by heat due to burning of the current collector material. However, in the battery above, the current collector film can be formed before formation of the electrolyte film, thereby enabling damage to the electrolyte film to be avoided.

Preferably, in the battery, the electrolyte film is a positive electrode electrolyte film including a positive electrode active material.

In the battery, at least a part of the current collector film and at least a part of the positive electrode electrolyte film are overlapped with each other, thereby facilitating electron movement between the current collector film and the positive electrode electrolyte film. As a result, the positive electrode electrolyte film allows activation of electric chemical reaction.

Preferably, in the battery, the electrolyte film is a negative electrode electrolyte film including a negative electrode active material.

In the battery, at least a part of the current collector film and at least a part of the negative electrode electrolyte film are overlapped with each other, thereby facilitating electron movement between the current collector film and the negative electrode electrolyte film. As a result, the negative electrode electrolyte film allows activation of electric chemical reaction.

Preferably, in the battery, the films include a plurality of electrolyte films, at least a pair of the electrolyte films being arranged adjacent to each other in such a manner that at least a part of one of the adjacent electrolyte films is overlapped with at least a part of an other one of the adjacent electrolyte films.

In the battery, the adjacent electrolyte films are at least partially overlapped with each other. The electrolyte films allow movement of an ionized substance. Due to the at least partial overlapping between the electrolyte films, a contact area between the electrolyte films is largely formed. Consequently, the ionized substance can easily move between the adjacent electrolyte films.

In addition, preferably, in the battery above, the electrolyte films include a positive electrode electrolyte film including a positive electrode active material and an intermediate electrolyte film including no active material, the positive electrode electrolyte film being arranged adjacent to the intermediate electrolyte film in such a manner that at least a part of the positive electrode electrolyte film is overlapped with at least a part of the intermediate electrolyte film.

In the battery, the positive electrode electrolyte film and the intermediate electrolyte film adjacent are overlapped with each other. Thus, an ionized substance can easily move between the positive electrode electrolyte film and the intermediate electrolyte film. As a result, the positive electrode electrolyte film allows activation of electric chemical reaction.

Preferably, in the above battery, the electrolyte films include a negative electrode electrolyte film including a negative electrode active material and an intermediate electrolyte film including no active material, the negative electrode electrolyte film being arranged adjacent to the intermediate electrolyte film in such a manner that at least a part of the negative electrode electrolyte film is overlapped with at least a part of the intermediate electrolyte film.

In the battery, the negative electrode electrolyte film and the intermediate electrolyte film adjacent are overlapped with each other. Thus, an ionized substance can easily move between the negative electrode electrolyte film and the intermediate electrolyte film. As a result, the negative electrode electrolyte film allows activation of electric chemical reaction.

A method for producing a battery according to a second aspect of the invention includes arranging a current collector film on a surface of a base member and arranging an electrolyte film on the surface of the base member, the electrolyte film being arranged after arranging the current collector film so as to be adjacent to the current collector film in such a manner that at least a part of the current collector film is overlapped with at least a part of the electrolyte film.

In the battery producing method, the electrolyte film is formed after formation of the current collector film. In general, a current collector film is made of a highly conductive material and thus is often made of metal. In that case, the current collector film is formed by applying and burning metal microparticles. Thus, if the current collector film is formed after arranging the electrolyte film, heat due to burning of the current collector material can damage the electrolyte film. However, in the method of the second aspect, the current collector film is formed before formation of the electrolyte film, so that damage to the electrolyte film can be avoided.

### BRIEF DESCRIPTION OF THE DRAWINGS

The invention will be described with reference to the accompanying drawings, wherein like numbers reference like elements.

FIG. 1A is a schematic perspective view of a battery according to a first embodiment of the invention.

FIG. 1B is a schematic sectional view taken along line A-A″ of the battery shown in FIG. 1A.

FIG. 1C is a schematic plan view of a battery substrate.

FIG. 1D is a schematic sectional view of a main section of the battery substrate shown in FIG. 1C.

FIG. 2 is a schematic perspective view showing a structure of a liquid droplet ejecting apparatus.

FIG. 3A is a schematic plan view of a carriage included in the ejecting apparatus.

FIG. 4 is a flowchart showing a process of producing the battery.

FIGS. 5A to 5C are illustrations showing a method for producing the battery.

FIGS. 6A to 6E are illustrations showing the method for producing the battery.

FIGS. 7A to 7D are illustrations showing the method for producing the battery.

FIGS. 8A to 8C are illustrations showing the method for producing the battery.

FIGS. 9A to 9C are illustrations showing the method for producing the battery.

FIGS. 10A to 10D are illustrations showing the method for producing the battery.

FIGS. 11A and 11B are illustrations showing the method for producing the battery.

FIG. 12 is a sectional view showing a main section of a battery substrate of a battery according to a second embodiment of the invention.

FIG. 13 is a flowchart showing a process of producing the battery of the second embodiment.

FIG. 14 is sectional view showing a main section of a battery substrate of a battery according to a third embodiment of the invention.

FIG. 15 is a sectional view showing a main section of a battery substrate of a battery according to a fourth embodiment of the invention.

FIG. 16 is a sectional view of a battery according to a modification of the first embodiment.

### DESCRIPTION OF EXEMPLARY EMBODIMENTS

Embodiments of the invention will be described in detail by referring to the drawings.

Each of constituent members is shown using different scales in each of the drawings such that each of the members has a recognizable size in each drawing.

### First Embodiment

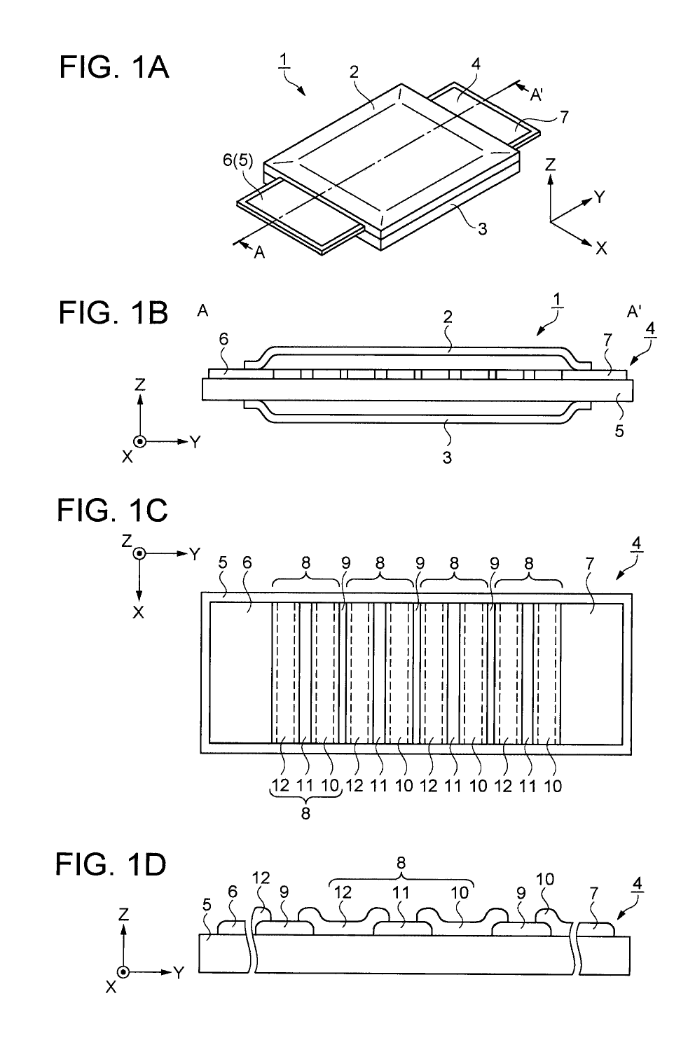

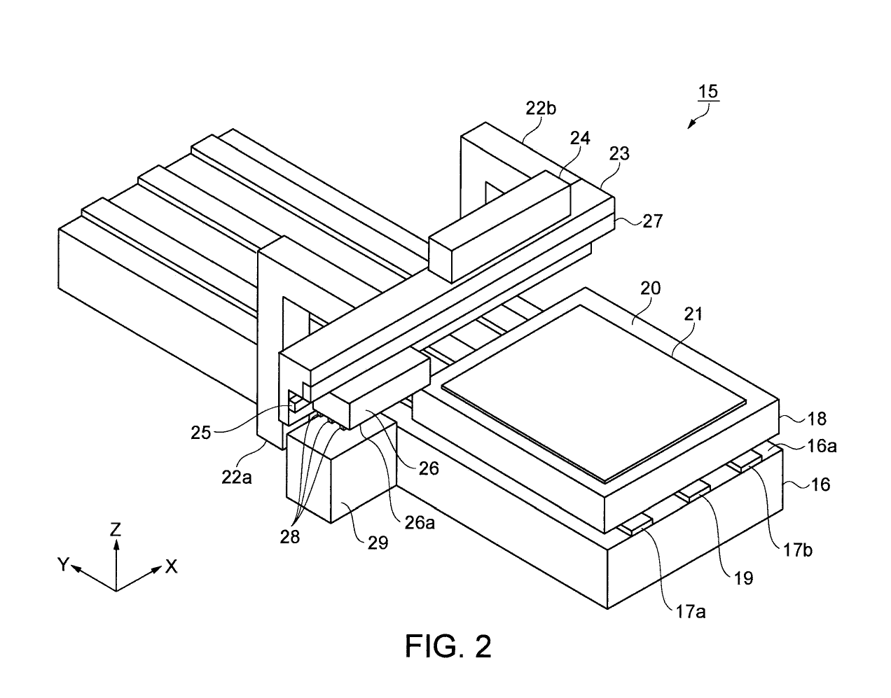

With reference to FIG. 1A to FIG. 11B, a description will be given of a battery and a battery production method according to a first embodiment of the invention.

Battery

First, a battery 1 of the embodiment will be described by referring to FIGS. 1A to 1D. FIG. 1A is a schematic perspective view showing the battery 1. FIG. 1B is a schematic sectional view taken along line A-A′ of the battery shown in FIG. 1A. As in FIGS. 1A and 1B, the battery 1 includes an upper outer casing 2 and a lower outer casing 3 each having a rectangular sheet-like shape. The upper outer casing 2 and the lower outer casing 3 are closely adhered together around outer peripheries of the casings 2 and 3. At opposite sides of the battery 1, a battery substrate 4 is arranged so as to protrude from between the upper and the lower outer casings 2 and 3. The battery substrate 4 includes a substrate 5 as a base member. On an end of the substrate 5 is arranged a negative electrode current collector film 6 as a film and a current collector film. On an other end of the substrate 5 opposite to the end thereof where the negative electrode current film 6 is arranged, there is arranged a positive electrode current collector film 7 as a film and a current collector film. The negative electrode current collector film 6 is a negative electrode terminal of the battery 1 and the positive electrode current collector film 7 is a positive electrode terminal of the battery 1. A direction in which the negative electrode current collector film 6 and the positive electrode current collector film 7 are arranged is referred to as a Y direction, and a direction orthogonal to the Y direction is referred to as an X direction. A thickness direction of the battery 1 is referred to as a Z direction.

Preferably, each of the upper and the lower outer casings 2 and 3 is made of a highly insulating material having high tensile strength and high impact resistance, thus being hard to rupture, with highly thermal conductivity. For example, each of the upper and the lower casings 2 and 3 may be made of a polymer metal composite film formed by a laminate of a metal foil and a resin film, an aluminum laminate film, a polyethylene terephthalate film, or a film made of a polyolefin material such as polyethylene or polypropylene. In the present embodiment, each casing may be made of an aluminum laminate film, for example.

FIG. 1C is a schematic plan view showing the battery substrate 4. As shown in FIG. 1C, the battery substrate 4 includes the negative electrode current collector film 6 and the positive electrode current collector film 7 on the opposite ends of the substrate 5. Between the negative electrode current collector film 6 and the positive electrode current collector film 7, there are alternately arranged electrolyte patterns 8, and intermediate current collector films 9 each as a film and a current collector film. Each of the electrolyte patterns 8 includes a positive electrode electrolyte film 10, an intermediate electrolyte film 11, and a negative electrode electrolyte film 12 each as a film and an electrolyte film, which are arranged in that order. The negative electrode current collector film 6 and the negative electrode electrolyte film 12 are arranged adjacent to each other, and the positive electrode current collector film 7 and the positive electrode electrolyte film 10 are arranged adjacent to each other. The films are linearly formed and arranged in parallel to each other. In the embodiment, for example, a single battery substrate 4 includes four electrolyte patterns 8 arranged thereon, where three intermediate current collector films 9 are arranged among the four electrolyte patterns 8. Numbers of the electrolyte patterns 8 and the intermediate current collector films 9 are not restricted to particular ones and may be determined according to a size and a capability of the battery substrate 4.

FIG. 1D is a schematic sectional view showing a main section of the battery substrate 4. As shown in FIG. 1D, the positive electrode electrolyte film 10 is arranged adjacent to one of the intermediate current collector films 9 in such a manner that a part of the positive electrode electrolyte film 10 is overlapped on the intermediate current collector film 9. Additionally, the positive electrode electrolyte film 10 is arranged adjacent to the intermediate electrolyte film 11 in such a manner that an other part of the positive electrode electrolyte film 10 is overlapped on the intermediate electrolyte film 11. The intermediate electrolyte film 11 is arranged adjacent to the negative electrode electrolyte film 12 in such a manner that a part of the negative electrode electrolyte film 12 is overlapped on the intermediate electrolyte film 11. Furthermore, the negative electrode electrolyte film 12 is arranged adjacent to another one of the intermediate current collector films 9 in such a manner that an other part of the negative electrode electrolyte film 12 is overlapped on the intermediate current collector film 9. Thus, at least a part of one of the films adjacent to each other is overlapped with an adjacent one of the films.

Similarly, the negative electrode electrolyte film 12 is arranged adjacent to the negative electrode current collector film 6 in such a manner that a part of the negative electrode electrolyte film 12 is overlapped on the negative electrode current collector film 6. In addition, the positive electrode electrolyte film 10 is arranged adjacent to the positive electrode current collector film 7 in such a manner that a part of the positive electrode electrolyte film 10 is overlapped on the positive electrode current collector film 7.

A material of the substrate 5 is not restricted as long as the substrate is an insulating plate or sheet. The substrate 5 may be a glass plate or a silicon plate. Other examples of the substrate 5 include a resin plate made of polypropylene, polyimide, polyester, or the like and a substrate formed by a mixture of a resin and an insulating material, such as a paper phenol substrate, a paper epoxy substrate, a glass composite substrate, or a glass epoxy substrate. The substrate 5 does not have to be a rigid member and may be a flexible sheet. In the embodiment, for example, a polypropylene plate is used as the substrate 5. In addition, the substrate 5 does not necessarily have to be a plate-shaped member as long as the substrate 5 has a surface where the electrolyte patterns 8 and the current collector films can be formed.

The negative electrode current collector film 6, the positive electrode current collector film 7, and the intermediate current collector films 9 may be made of a conductive material, and, for example, may be a film, a metal foil, an electrolytic foil, or a rolled foil formed of metal microparticles of aluminum, stainless steel, copper, nickel, silver, or the like. The present embodiment uses a film formed of aluminum microparticles, for example. A thickness of each of the current collector films is not specifically restricted and is preferably set to a value that can maintain strength of the current collector film. For example, in general, the thickness of the each current collector film in the embodiment may be set to a range of 5 to 30 μm.

The positive electrode electrolyte film 10 is made of a material including a positive electrode active material, an electric conduction aid, metal particles, a binding agent, an electrolyte material (an electrolyte supporting salt and an electrolytic polymer), and an additive. The positive electrode active material may be a complex oxide of a transition metal and lithium (a lithium-transition metal complex oxide), which is, for example, a Li—Mn complex oxide such as LiMnO₂, LiMn₂O₄ or a Li₂MnO₄, a Li—Co complex oxide such as LiCoO₂, a Li—Cr complex oxide such as Li₂Cr₂O₇ or Li₂CrO₄, or a Li—Ni complex oxide such as LiNi O₂. Other examples of the complex oxide include a Li—Ni—Co complex oxide such as LiNi1-xCox O₂, a Li—Ni—Mn complex oxide such as LiNi1/2Mn1/2 O₂, a Li—Ni—Mn—Co complex oxide such as Lini1/3Mn1/3Co1/3O₂, and a Li—Ti complex oxide such as Li₄Ti₅ O₁₂. In addition, the positive electrode active material may be selected from Li—Fe complex oxides such as LixFeOy and LiFeO₂, lithium iron phosphate compounds such as LiFeP O₄, lithium sulfides such as Li₂S, and the like. These compounds are merely examples and other various options can be used. For example, the embodiment uses Li₂MnO₄ as the positive electrode active material.

As examples of the electric conduction aid, there may be mentioned acetylene black, carbon black, graphite, carbon fibers, and carbon nanotube. These are some of the examples thereof, and any of other various compounds can be selected for the electric conduction aid. In the embodiment, for example, the electric conduction aid is acetylene black. The metal particles are microparticles of a same metal as that of the negative electrode current collector film 6. For example, the metal particles in the embodiment are aluminum microparticles.

As the binding agent, there may be mentioned polyvinylidene fluoride, styrene-butadiene rubber, polyimide, or the like. These are merely examples of the binding agent, and other known binding agents can be used. In addition, if micro particles of the positive electrode active material are bonded together by an electrolytic polymer even without using any binding agent, no binding agent is necessarily required. In the embodiment, for example, polyvinylidene fluoride is used as the binding agent.

The electrolyte supporting salt may be a known lithium salt such as LiBETI (lithium bis (perfluoroethylene sulfonyl) imide, which is also referred to as Li(C₂F₅SO₂)₂N). Other examples of the electrolyte supporting salt include LiBF₄, LiPF₆, LiN(SO₂CF₃)₂, LiN(SO₂C₂F₅)₂, LiBOB (lithium bis oxide borate), and mixtures thereof. The electrolyte supporting salt is not restricted to these examples and may be selected from other various materials. For example, the embodiment uses LiBETI as the electrolyte supporting salt.

The electrolytic polymer may be polyethylene oxide (PEO), polypropylene oxide (PPO), copolymers thereof, or the like. These polyalkylene oxide polymers are characterized by having a function of transmitting ions to facilitate dissolution of the lithium salts as mentioned above. In addition, the polyalkylene oxide polymers have mechanical strength that is increased after polymerization. For example, the embodiment uses polyethylene oxide as the electrolytic polymer. The additive may be trifluoropropylene carbonate that improves performance and life span of the battery, and furthermore, a reinforcing agent such as any of various fillers may be used if needed. If the battery can exhibit good performance without such an additive, no additive is necessarily required. Additionally, to polymerize the electrolytic polymer, a polymerization initiator may be used. The polymerization initiator acts on a cross-linking group of the electrolytic polymer to promote a cross linking reaction and is appropriately selected according to each polymerization method (such as thermal polymerization, photo polymerization, radiation polymerization, or electron beam polymerization). For example, benzyl dimethyl ketal may be used as a photo polymerization initiator and azobis isobutyronitrile may be used as a thermal polymerization initiator, although these are merely examples as the polymerization initiator. The embodiment uses, for example, azobis isobutyronitrile as the polymerization initiator.

The intermediate electrolyte film 11 is made of a material including an electrolyte material (an electrolyte supporting salt and an electrolytic polymer), and an additive. The material may be the same as that of the positive electrode electrolyte film 10. For example, the embodiment uses polyethylene oxide as the electrolytic polymer and uses LiBETI as the electrolyte supporting salt.

The negative electrode electrolyte film 12 is made of a material including a negative electrode active material, an electric conduction aid, a binding agent, an electrolyte material (an electrolyte supporting salt and an electrolytic polymer), and an additive. The negative electrode active material may be any one of various known graphite such as graphite carbon, hard carbon, and soft carbon, as well as any one of known metal compounds, metal oxides, Li metal oxides (including lithium-transition metal complex oxides), boron-added carbons, lithium-titanium complex oxides such as Li₄Ti₅O₁₂, silicon compounds such as Li₂₂Si₅, carbon compounds such as LiC₆, lithium metals, and the like. These compounds are used alone or in combinations. The negative electrode active material is not restricted to those mentioned above and may be appropriately selected from conventionally known compound materials. For example, the embodiment uses Li₄Ti₅O₁₂ as the negative electrode active material.

The electric conduction aid, the binding agent, and the electrolyte material may be the same as those of the positive electrode electrolyte film 10. If graphite is used as the negative electrode active material, no electric conduction aid is necessarily required. For example, the embodiment uses acetylene as the electric conduction aid and polyvinylidene fluoride as the binding agent. Additionally, for example, polyethylene oxide may be used as the electrolytic polymer and LiBETI may be used as the electrolyte supporting salt.

The each positive electrode electrolyte film 10, the each electrolyte pattern 8, and the each negative electrode electrolyte film 12 may be formed so as to have large thicknesses, since the films and the pattern having larger thicknesses can contain a large amount of an ionized substance as compared to those having smaller thicknesses, so that the battery 1 can store a large amount of charge. The thickness of each of the films 10, 12, and the pattern 8 is not specifically restricted. In the embodiment, for example, the thickness of each of films 10, 12, and the pattern 8 is set in a range of 5 to 30 μm.

To charge the battery 1, the battery 1 is connected to a not-shown charging device to apply a voltage to the battery 1, whereby a lithium metal included in the positive electrode is ionized into lithium ions. The lithium ions move to the negative electrode electrolyte film 12 via the intermediate electrolyte film 11. In the negative electrode electrolyte film 12, an electron is supplied to the lithium ion to form a compound including the lithium metal.

To discharge the battery 1, the battery 1 is connected to a not-shown electrical load, whereby the lithium metal included in the negative electrode electrolyte film 12 is ionized into lithium ions. The lithium ions move to the positive electrode electrolyte film 10 via the intermediate electrolyte film 11. The negative electrode electrolyte film 12 releases an electron, which, in turn, moves into the positive electrode electrolyte film 10 via the negative electrode current collector film 6, the electrical load, and the positive electrode current collector film 7. Consequently, the lithium ion and the electron are supplied to the positive electrode electrolyte film 10, whereby the lithium ion is bonded with the electron to form a compound including a lithium metal.

As described above, upon charging and discharging of the battery 1, the lithium ion moves among the positive electrode electrolyte film 10, the intermediate electrolyte film 11, and the negative electrode electrolyte film 12, and the electron move between the negative electrode current collector film 6 and the negative electrode electrolyte film 12. In addition, the electron moves between the positive electrode current collector film 7 and the positive electrode electrolyte film 10, moves between the intermediate current collector film 9 and the negative electrode electrolyte film 12, and moves between the intermediate current collector film 9 and the positive electrode current collector film 7. Thus, facilitating the movement of the lithium ion and the electron can increase output of the battery 1.

Liquid Droplet Ejecting Apparatus

FIG. 2 is a schematic perspective view showing a structure of a liquid droplet ejecting apparatus. A liquid droplet ejecting apparatus 15 ejects and applies a function liquid including the composition materials of each of the films. As shown in FIG. 2, the liquid droplet ejecting apparatus 15 includes a base board 16 having a rectangular parallelepiped shape. In the present embodiment, a longitudinal direction of the base board 16 is referred to as Y direction and a direction orthogonal to the Y direction is referred to as X direction.

On an upper surface 16a of the base board 16, a pair of guide rails 17a and 17b extended in the Y direction are provided so as to protrude across an entire width of the Y direction. Above the base board 16 is mounted a stage 18 having a not-shown linear motion mechanism corresponding to the pair of guide rails 17a and 17b. The stage 18 is movable in the Y direction.

In addition, on the upper surface 16a of the base board 16, there is also provided a main scanning position detector 19 parallel to the guide rails 17a and 17b to measure a position of the stage 18. On an upper surface of the stage 18 is formed a mounting surface 20 with a not-shown adsorption-type substrate chucking mechanism. A substrate 21 is mounted on the mounting surface 20 to place the substrate 21 in a predetermined position on the mounting surface 20. Then, the substrate chucking mechanism allows the substrate 21 to be fixed to the mounting surface 20.

On opposite sides of the X direction of the base board 16, a pair of supporting members 22a and 22b are provided in a standing manner, and a guide member 23 is extended in the X direction so as to connect the pair of supporting members 22a and 22b. The guide member 23 has a longitudinal width longer than a width of an X direction of the stage 18, so that an end of the guide member 23 is protruded from the supporting member 22a. On an upper part of the guide member 23 is provided a container tank 24 containing a liquid to be ejected, where the liquid is contained in a suppliable manner. On a lower part of the guide member 23 is provided a guide rail 25 protrudingly extended in the X direction across the entire width of the X direction.

A carriage 26 is provided so as to be movable along the guide rail 25 and has roughly a rectangular parallelepiped shape. The carriage 26 has a linear motion mechanism and is movable in the X direction. Between the guide member 23 and the carriage 26 is provided a sub scanning position detector 27 to measure a position of the carriage 26. On a lower surface 26a of the carriage 26 facing the stage 18 are protrudingly provided a plurality of liquid droplet ejecting heads 28. Thereby, with relative movements between the stage 18 and the carriage 26, the liquid droplet ejecting heads 28 eject liquid droplets to allow drawing of a desired pattern.

Additionally, there is provided a maintenance unit 29 at a place that is on a side surface of the base board 16 opposite to the X direction and facing a moving range of the carriage 26. The maintenance unit 29 serves as a cleaning mechanism for the liquid droplet ejecting heads 28. Cleaning the ejecting heads 28 enables the heads 28 to be maintained in a normally ejectable condition.

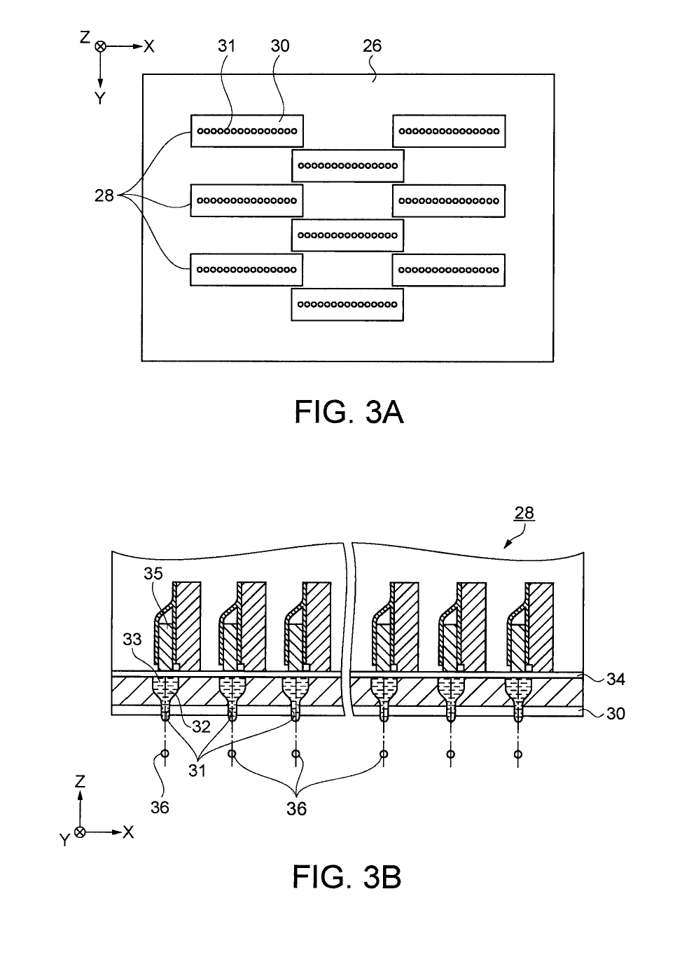

FIG. 3A is a schematic plan view of the carriage 26. As shown in FIG. 3A, the carriage 26 includes nine liquid droplet ejecting heads 28. Each of the ejecting heads 28 has a nozzle plate 30 on a lower surface thereof. On each nozzle plate 30, a plurality of nozzles 31 are arranged in the X direction at a predetermined distance from each other.

FIG. 3B is a schematic sectional view of a main section for illustrating a structure of the liquid droplet ejecting head 28. As shown in FIG. 3B, a cavity 32 is formed in a position facing each nozzle 31 on an upper part of the nozzle plate 30. The cavity 32 receives a function liquid 33 as a material liquid stored in the container tank 24. On an upper part of the cavity 32 are provided a vibrating plate 34 vibrating vertically to increase or reduce a capacity of the cavity 23 and a piezoelectric element 35 vertically expanding or shrinking to cause the vibrating plate 34 to vibrate. The piezoelectric element 35 vertically expands or shrinks to vibrate the vibrating plate 34, which thereby increases or reduces the capacity of the cavity 32, thereby allowing the function liquid 33 supplied into the cavity 32 to be ejected as a liquid droplet 36 from the nozzle 31.

Specifically, when the liquid droplet ejecting head 28 receives a nozzle driving signal that drive-controls the piezoelectric element 35, the piezoelectric element 35 is expanded to press the vibrating plate 34, thereby reducing the capacity of the cavity 32. As a result, the liquid droplet 36 of the function liquid 33 equivalent to an amount of the reduced capacity is ejected from the nozzle 31 of the ejecting head 28.

Method for Producing Battery

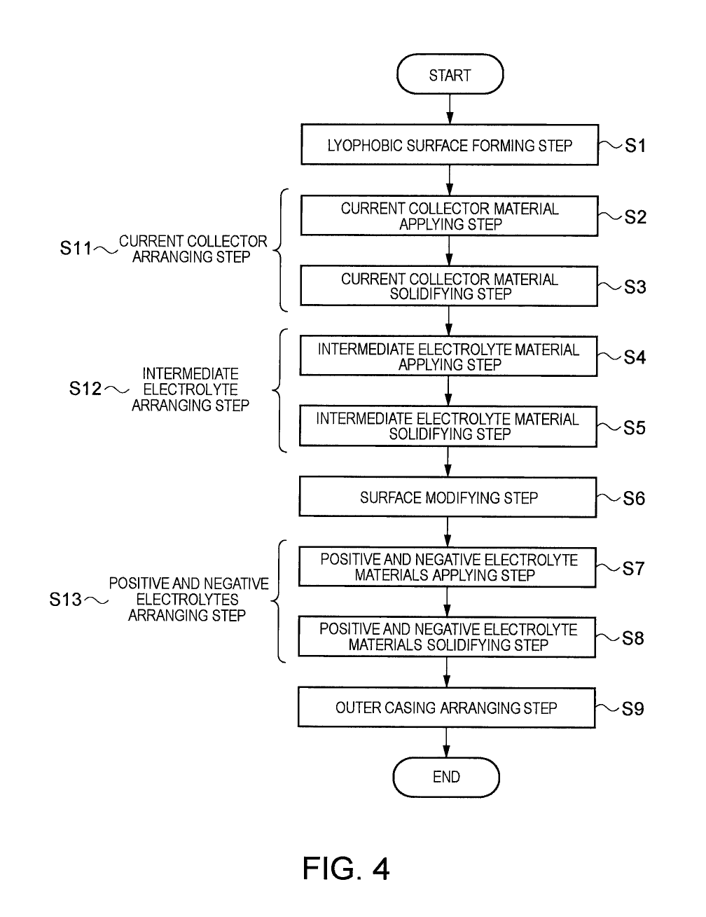

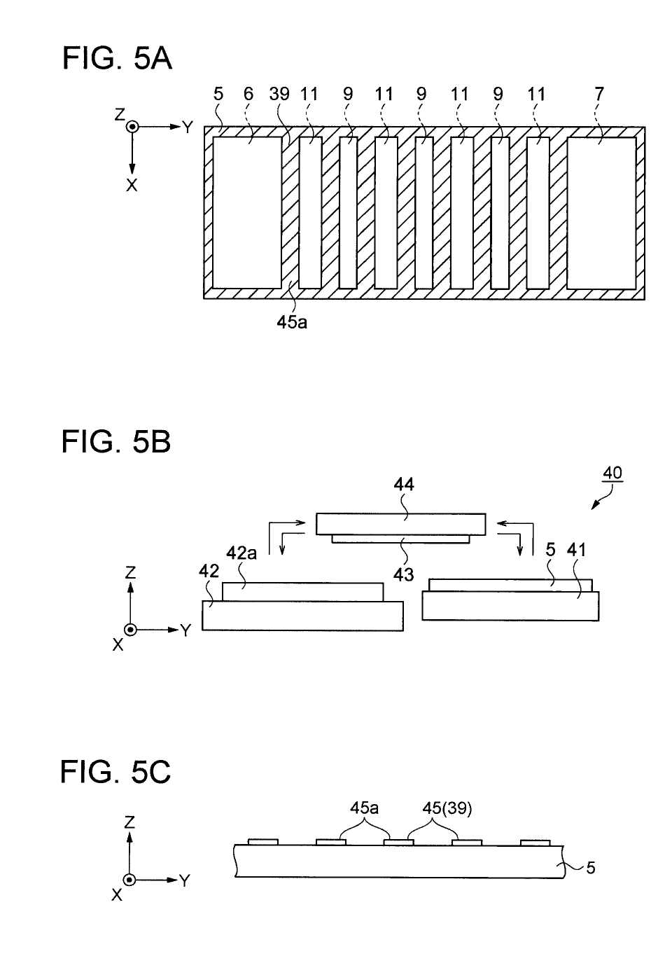

Next, a method for producing the battery 1 using the liquid droplet ejecting apparatus 15 will be described with reference to FIGS. 4 to 11B. FIG. 4 is a flowchart showing a process of producing the battery 1. FIGS. 5A to 11B are illustrations of the battery production method.

In the flowchart shown in FIG. 4, step S1 corresponds to a lyophobic surface forming step that forms a lyophobic surface on an upper surface of the substrate. Next will be step S2, which corresponds to a current collector material applying step that applies and dries a function liquid including a current collector material. Then, at step S3 as a current collector material solidifying step, the applied function liquid including the current collector material is burned to be solidified. Steps S2 and S3 are included in step S11 as a current collector arranging step that arranges each of the current collector films. Next, at step S4 as an intermediate electrolyte material applying step, a function liquid including an electrolyte supporting salt and an electrolytic polymer is applied and dried, which is followed by step S5 as an intermediate electrolyte material solidifying step. At step S5, the applied electrolytic polymer is polymerized. Steps S4 and S5 are included in step S12 as an intermediate electrolyte arranging step that arranges the intermediate electrolyte film. Next will be step S6.

Step S6 corresponds to a surface modifying step that eliminates a lyophobic property of the lyophobic surface formed at step S1 and forms a lyophobic surface at a place different from the place where the lyophobic property was eliminated. Next will be step S7, which corresponds to a positive and negative electrolyte materials applying step. At this step, a function liquid containing a material including a positive electrode active material, an electric conduction aid, a binding agent, an electrolytic polymer, an electrolyte supporting salt, and an additive is applied to a place intended to form the positive electrode electrolyte film. In addition, a function liquid containing a material including a negative electrode active material, an electric conduction aid, a binding agent, an electrolytic polymer, an electrolyte supporting salt, and an additive is applied to a place intended to form the negative electrode electrolyte film. Thereafter, the applied function liquids are dried. Next, step S8 will be performed. Step S8 corresponds to a positive and negative electrolyte materials solidifying step that polymerizes the electrolytic polymer included in the function liquid applied to form each of the positive and the negative electrode electrolyte films. Steps S7 and S8 are included in step S13 as a positive and negative electrolytes arranging step that arranges the positive electrode electrolyte film and the negative electrode electrolyte film. Thus, step S12 as the intermediate electrolyte arranging step and step S13 as the positive and negative electrolytes arranging step are included in an electrolyte arranging step performed after step S11 as the current collector arranging step. Step S9 corresponds to an outer casing arranging step that arranges the outer casing components. Thus, the battery producing process ends through the steps.

Next, the battery producing process will be described in detail with reference to FIGS. 5A to 11B. FIGS. 5A and 5B illustrate step S1 as the lyophobic surface forming step. In FIG. 5A, a lyophobic region 39 indicated by oblique lines is a region intended to form the lyophobic surface. The lyophobic region 39 is arranged so as to surround a place intended to form each of the negative electrode current collector film 6, the positive electrode current collector film 7, the intermediate current collector films 9, and the intermediate electrolyte films 11.

As shown in FIG. 5B, the lyophobic surface is formed using a microcontact printing method as a relief printing technique. The method is performed by a printer 40 that can print micro-patterns.

The printer 40 includes a mounting board 41 and a stamp board 42, and a stamp 43. The mounting board 41, which is used to mount the substrate 5 where printing is performed, has a mechanism adsorbing and retaining the substrate 5. On the stamp board 42 is provided a receiving saucer with an ink mat 42a made of porous resin arranged therein. On the ink mat 42a is provided a liquid material to form a lyophobic film. The liquid material is prepared by dissolving a lyophobic raw material in a solvent. For example, the embodiment uses a liquid material prepared by diluting Optool DSX (manufactured by Daikin Chemical Co., Ltd.) by a fluorine solvent.

The stamp 43 is retained by a stage 44. The stage 44 includes an elevation mechanism and a linear motion mechanism. The stage 44 moves to a position opposing the ink mat 42a and descends to press the stamp 43 against the ink mat 42a. Next, the stage 44 ascends to move to a position opposing the substrate 5 and then descends to press the stamp 43 against the substrate 5. In short, the printer 40 performs printing of the liquid material on the substrate 5.

The stamp 43 is made of an elastic resin or the like. For example, the embodiment uses silicone rubber. The stamp 43 has a pattern corresponding to the lyophobic region 39 formed thereon. The pattern is a high-precision pattern formed by photolithography or electron beam lithography.

Using the stamp 43, the lyophobic film-forming liquid material is transferred onto the substrate 5. Next, the applied liquid material is dried and solidified. As a result, as shown in FIG. 5C, a lyophobic film 45 is formed on the substrate 5. The lyophobic film 45 has an upper surface as a lyophobic surface 45a.

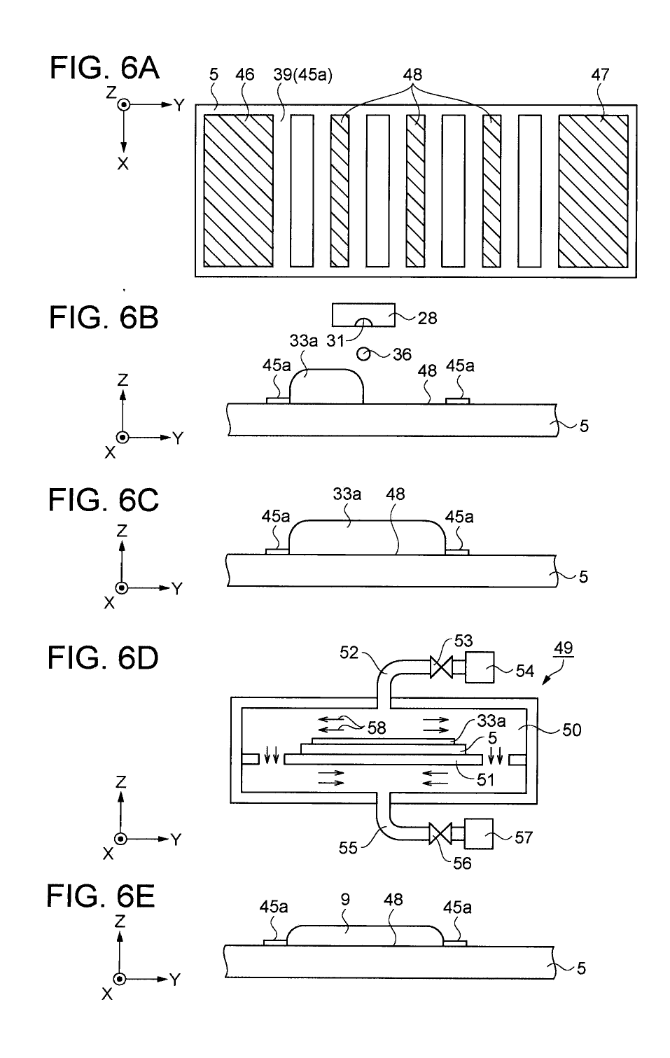

FIGS. 6A and 6B illustrate step S2 as the current collector material applying step. At step S2, the function liquid 33 including the material of the current collector is applied to a negative electrode current collector arranging place 46, a positive electrode current collector arranging place 47, and an intermediate current collector arranging place 48 shown in FIG. 6A. The current collector arranging places 46, 47, and 48, respectively, are those intended to arrange the negative electrode current collector film 6, the positive electrode current collector film 7, and the intermediate current collector film 9, respectively.

Then, as shown in FIG. 6B, the nozzle 31 of the liquid droplet ejecting head 28 ejects the liquid droplet 36 on the intermediate current collector arranging place 48. The liquid droplet 36 is composed of a first function liquid 33a that is a liquid obtained by dispersing the material of the current collector in a dispersion medium.

The dispersion medium is not restricted to a specific one and preferably has a boiling point of 50 to 200° C. at atmospheric pressure from a viewpoint of work efficiency. The dispersion medium may be any one of amide solvents such as N-methylpyrrolidone, N,N-dimethylformamide, and N-dimethylacetamide and nitrile solvents such as acetonitrile and propionitrile. In addition, there may be mentioned ether solvents such as tetrahydrofuran, 1,2-dimethoxyethane, and diisopropyl ether, and ketone solvents such as acetone, ethyl methyl ketone, diethyl ketone, isobutyl methyl ketone, and cyclohexanone, as well as ester solvents such as ethyl acetate, propyl acetate, and methyl lactate, aromatic solvents such as benzene, toluene, xylene, and chlorobenzene, halogen solvents such as chloroform, 1,2-dichloroethane, mixture solvents prepared by mixing two or more kinds of the solvents mentioned above, and the like. For example, the embodiment uses a mixture solution of propylene carbonate and N-methylpyrrolidone.

The lyophobic surface 45a is formed around the intermediate current collector arranging place 48, whereby the first function liquid 33a can be applied with high precision on the intermediate current collector arranging place 48. The same processing is performed on the negative and the positive electrode current collector arranging places 46 and 47. As a result, as shown in FIG. 6C, the first function liquid 33a is applied on the intermediate current collector arrangement intended place 48. Similarly, the first function liquid 33a is applied on the negative and the positive electrode current collector arrangement intended places 46 and 47.

Next, as shown in FIG. 6D, the substrate 5 having the first function liquid 33a applied thereon is placed inside a drying device 49. The drying device 49 includes a drying chamber 50. The drying chamber 50 has a mounting board 51 to mount the substrate 5 thereon. The drying chamber 50 is connected to a dry gas supply section 54 via a supply tube 52 and a supply valve 53 shown on an upper side of FIG. 6D, and is also connected to an exhaust section 57 via an exhaust tube 55 and an exhaust valve 56 shown on a lower side of the drawing. A dry gas 58 supplied from the dry gas supply section 54 is supplied to the drying chamber 50 via the supply valve 53 and the supply tube 52. Air pressure in the drying chamber 50 is controlled by controlling the dry gas supply section 54 and the exhaust section 57, whereby the first function liquid 33a can be dried under reduced pressure.

The dry gas 58 flows along the first function liquid 33a applied on the substrate 5. When the gas flows, the solvent and the dispersion medium included in the function liquid 33a are evaporated into the dry gas 58 to be removed, whereby the first function liquid 33a is dried. Drying of the first function liquid 33a results in formation of a film made of the material of the first function liquid 33a. Then, the dry gas 58 containing the dispersion medium passes through the exhaust tube 55 and the exhaust valve 56 to be exhausted into a not-shown processing device by the exhaust section 57.

Next, at step S3 as the current collector material solidifying step, a temperature of the drying chamber 50 is increased to burn the metal microparticles included in the first function liquid 33a. Consequently, as shown in FIG. 6E, the intermediate current collector film 9 is formed on the intermediate current collector arranging place 48. Similarly, the negative electrode current collector film 6 and the positive electrode current collector film 7, respectively, are formed on the negative electrode current collector arranging place 46 and the positive electrode current collector arranging place 47, respectively.

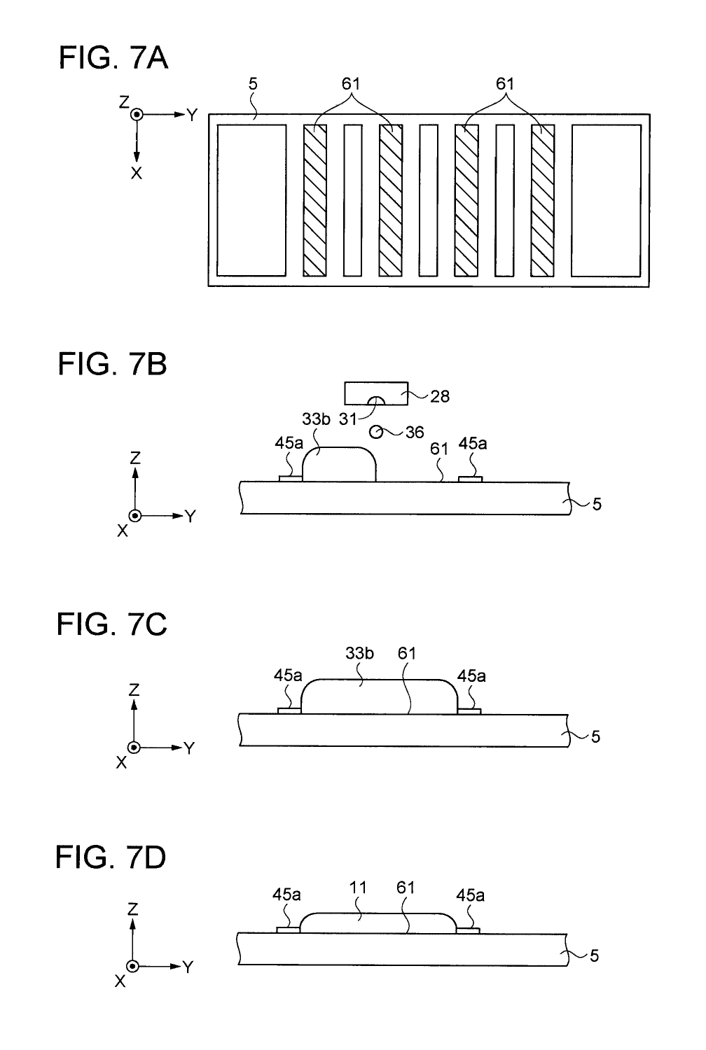

FIGS. 7A to 7C illustrate step S4 as the intermediate electrolyte material applying step. At step S4, a function liquid 33 including the material of the intermediate electrolyte film 11 is applied on each intermediate film arranging place 61 shown in FIG. 7A. The intermediate film arranging place 61 is a place intended to arrange the intermediate electrolyte film 11. Then, as shown in FIG. 7B, the nozzle 31 of the liquid droplet ejecting head 28 ejects the liquid droplet 36 on the each intermediate film arranging place 61. The liquid droplet 36 is composed of a second function liquid 33b. The second function liquid 33b is a liquid prepared by dissolving or dispersing the material of the intermediate electrolyte film 11 in a solvent or a dispersion medium. The solvent or the dispersion medium may be the same liquid as the dispersion medium used at step S2.

As a result, as shown in FIG. 7C, the second function liquid 33b is applied on the intermediate film arranging place 61. The lyophobic surface 45a is formed around the intermediate film arranging place 61, so that the second function liquid 33b can be applied with high precision on the intermediate film arranging place 61.

FIG. 7D illustrates step S5 as the intermediate electrolyte material solidifying step. At step S5, the second function liquid 33b is dried, as in step S3. Thereafter, the electrolytic polymer included in the second function liquid 33b is heated by the drying device 49 to be polymerized, thereby solidifying the second function liquid 33b. Consequently, as shown in FIG. 7D, the intermediate electrolyte film 11 is formed on the intermediate film arranging place 61.

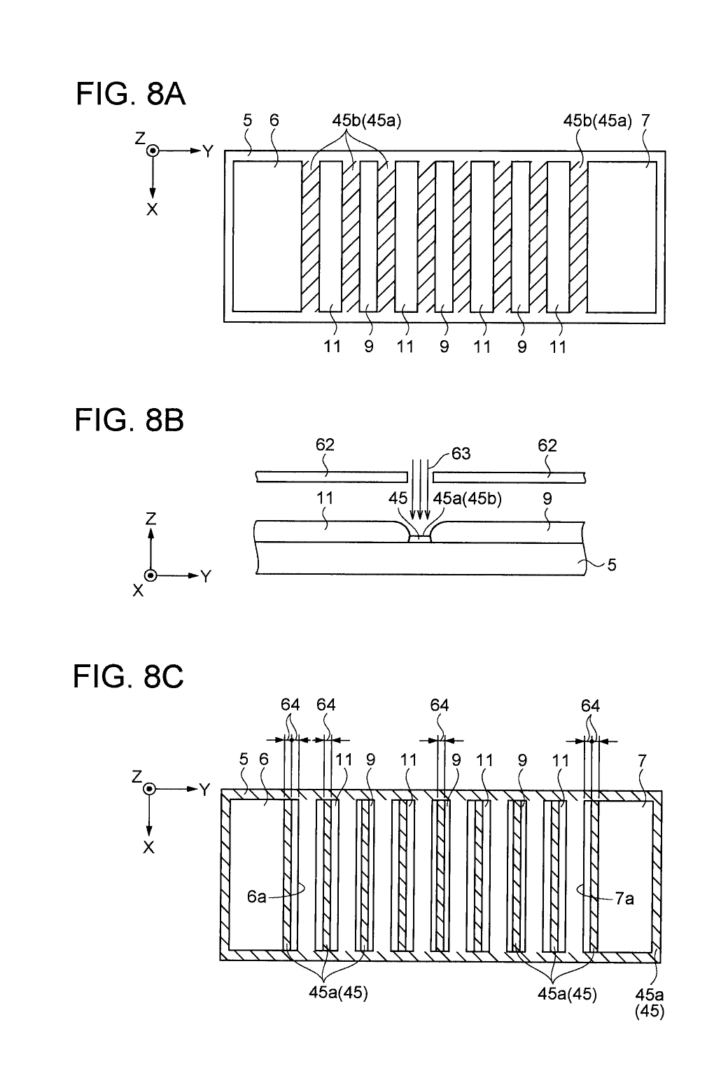

FIGS. 8A to 8C illustrate step S6 as the surface modifying step. FIG. 8A shows a lyophilic region 45b that is a region lyophilized by eliminating the lyophobic property on the lyophobic surface 45a. In the drawing, the lyophilic region 45b includes a region between the each intermediate current collector film 9 and the each intermediate electrolyte film 11. In addition, the lyophilic region 45b includes a region between the negative electrode current collector film 6 and the intermediate electrolyte film 11 and a region between the positive electrode current collector film 7 and the intermediate electrolyte film 11.

As shown in FIG. 8B, using a mask 62, a laser beam 63 is applied only to the region of the lyophobic surface 45a intended to form the lyophilic region 45b. The property of the region of the lyophobic surface 45a subjected to the laser irradiation is modified to eliminate the lyophobic property. Conditions for the laser irradiation, such as laser beam intensity and irradiation time are appropriately adjusted such that a surface of the lyophobic film 45 is lyophilized, in consideration of a material, a thickness, and the like of the lyophobic film 45. In addition, the beam to be applied may be any of laser beams such as an Nb:YAG laser beam and a carbon dioxide laser beam, UV light, and the like.

Next, the lyophobic film 45 is arranged on each of the negative current collector film 6, the positive current collector film 7, the intermediate current collector film 9, and the intermediate electrolyte film 11 to form the lyophobic surface 45a. The lyophobic film 45 is formed in the same manner as in the formation of the lyophobic film 45 performed at step S1.

FIG. 8C shows each place where the lyophobic surface 45a is to be formed. As in FIG. 8C, a width of the lyophobic film 45 arranged on the intermediate electrolyte film 11 is set to approximately a third of a width of the film 11. The width of the lyophobic film 45 is referred to as a lyophobic width 64. The lyophobic film 45 is arranged in a center of a width direction (the Y direction) of the intermediate electrolyte film 11. Similarly, a width of the lyophobic film 45 arranged on the intermediate current collector film 9 is also set to approximately a third of a width of the film 9. In the present embodiment, for example, the width of the intermediate electrolyte film 11 is set to be the same as that of the intermediate current collector film 9. Accordingly, the width of the lyophobic film 45 formed on the intermediate current collector film 9 and the width of the lyophobic film 45 formed on the intermediate electrolyte film 11 are set to be same as the lyophobic width 64. In addition, the lyophobic film 45 is arranged in a center of a width direction (the Y direction) of the intermediate current collector film 9.

The lyophobic film 45 on the negative electrode current collector film 6 is arranged in a position distant by a length of the lyophobic width 64 from an end 6a of the negative electrode current collector film 6 adjacent to the intermediate electrolyte film 11. The width of the lyophobic film 45 on the negative electrode current collector film 6 is also set to be the same as the lyophobic width 64. Similarly, the lyophobic film 45 on the positive electrode current collector film 7 is arranged in a position distant by the length of the lyophobic width 64 from an end 7a of the positive electrode current collector film 7 adjacent to the intermediate electrolyte film 11. The lyophobic film 45 on the positive electrode current collector film 7 is also set to have the same width as the lyophobic width 64. The position and the width of the lyophobic film 45 are not restricted to those described above and are preferably determined according to performance of the battery 1 and a degree of difficulty in producing the battery 1.

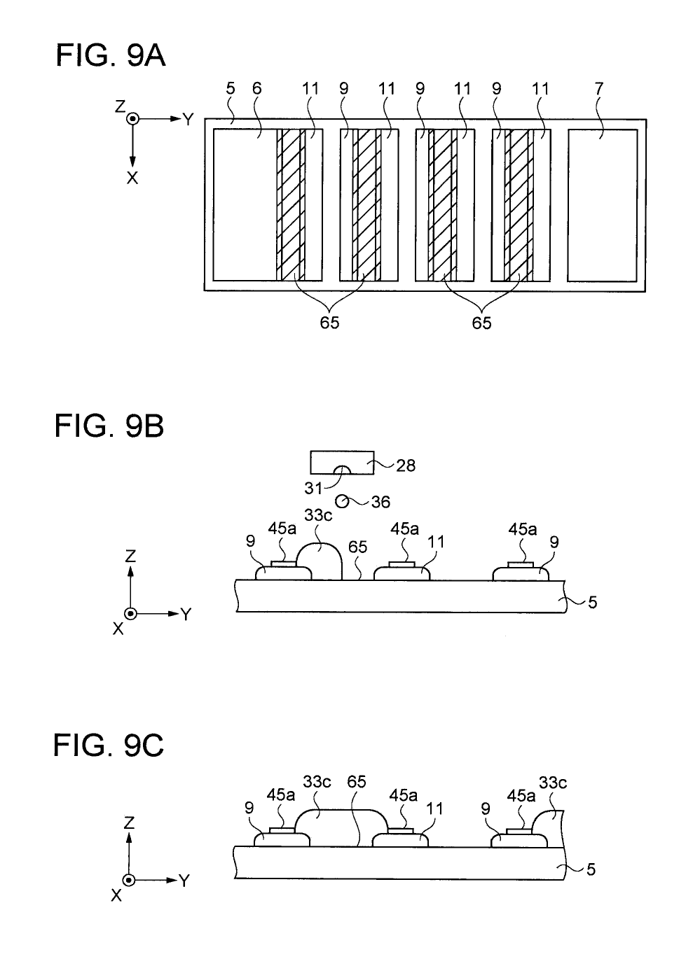

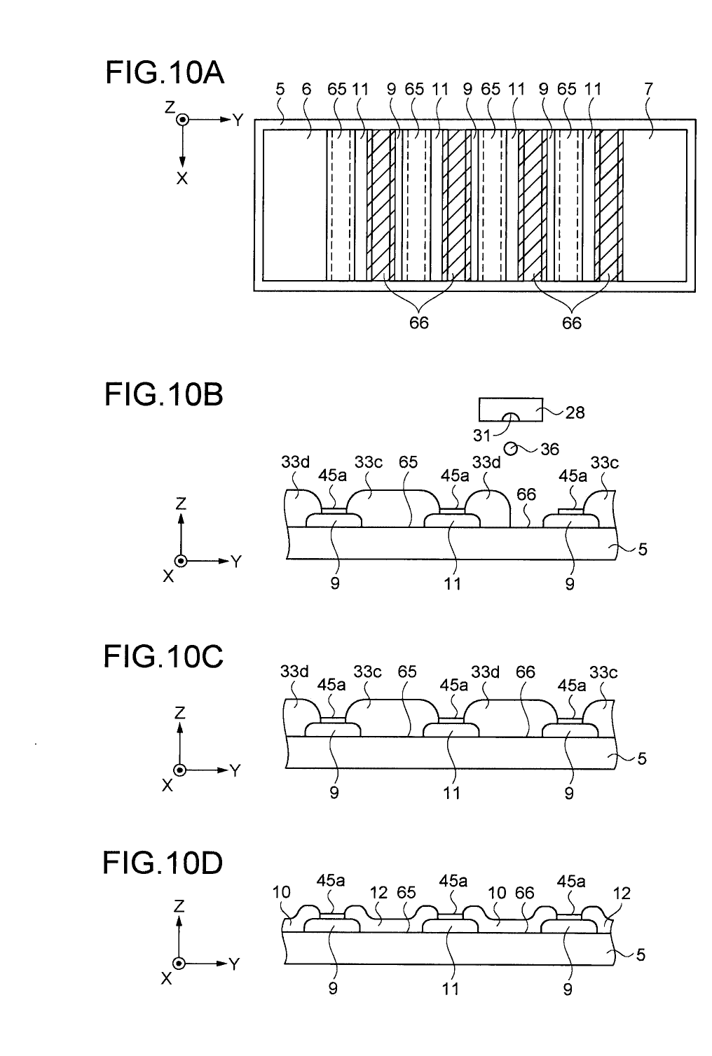

FIGS. 9A to 10C illustrate step S7 as the positive and negative electrolyte materials applying step. FIG. 9A shows each negative electrode electrolyte film arranging place 65 intended to apply the function liquid 33 including the material of the negative electrode electrolyte film 12. Between the intermediate current collector films 9 and the intermediate electrolyte films 11, places located at even-numbered positions from the negative electrode current collector film 6 are included in the negative electrode electrolyte film arranging place 65. In addition, the negative electrode electrolyte film arranging place 65 also includes a place between the negative electrode current collector film 6 and the intermediate electrolyte film 11.

Then, as shown in FIG. 9B, the nozzle 31 of the liquid droplet ejecting head 28 ejects the liquid droplet 36 on each of the negative electrode electrolyte film arranging places 65. The liquid droplet 36 is composed of a third function liquid 33c that is a liquid prepared by dissolving or dispersing the material of the negative electrode electrolyte film 12 in a solvent or a dispersion medium. The solvent or the dispersion medium is not restricted to a specific one, and, for example, may be the same as the dispersion medium used at step S2.

The lyophobic surface 45a is formed around the negative electrode electrolyte film arranging place 65, whereby the third function liquid 33c can be applied with high precision on the negative electrode electrolyte film arranging place 65. As a result, as shown in FIG. 9C, the third function liquid 33c is applied on the negative electrode electrolyte film arranging place 65.

FIG. 10A shows each positive electrode electrolyte film arranging place 66 intended to apply the function liquid 33 including the material of the positive electrode electrolyte film 10. Between the intermediate current collector films 9 and the intermediate electrolyte films 11, places other than the negative electrode electrolyte film arranging places 65 are included in the positive electrode electrolyte film arranging place 66. In addition, the positive electrode electrolyte film arranging place 66a also includes a place between the positive electrode current collector film 7 and the intermediate electrolyte film 11.

Then, as shown in FIG. 10B, the nozzle 31 of the liquid droplet ejecting head 28 ejects the liquid droplet 36 on each of the positive electrode electrolyte film arranging places 66. The liquid droplet 36 is composed of a fourth function liquid 33d that is a liquid prepared by dissolving or dispersing the material of the positive electrode electrolyte film 10 in a solvent or a dispersion medium. The solvent or the dispersion medium is not restricted to a specific one, and may be the same as the dispersion medium used at step S2.

The lyophobic surface 45a is formed around the positive electrode electrolyte film arranging place 66, whereby the fourth function liquid 33d can be applied with high precision on the positive electrode electrolyte film arranging place 66. As a result, as shown in FIG. 10C, the fourth function liquid 33d is applied on the positive electrode electrolyte film arranging place 66.

FIG. 10D illustrates step S8 as the positive and negative electrolyte materials solidifying step. At step S8, as in step S3, the third and the fourth function liquids 33c and 33d are dried by the drying device 49. Thereafter, the electrolyte polymer included in each of the third and the fourth function liquids 33c and 33d is polymerized by increasing the temperature of the drying chamber 50 to solidify each of the function liquids 33c and 33d. As a result, as shown in FIG. 10D, the negative electrode electrolyte film 12 is formed on the negative electrode electrolyte film arranging place 65, and the positive electrode electrolyte film 10 is formed on the positive electrode electrolyte film arranging place 66. An end of the negative electrode electrolyte film 12 is overlapped on the intermediate current collector film 9 and an other end of the film 12 is overlapped on the intermediate current collector film 11. Similarly, an end of the positive electrode electrolyte film 10 is overlapped on the intermediate current collector film 9 and an other end of the film 10 is overlapped on the intermediate current collector film 11. At this step, the battery substrate 4 is completed.

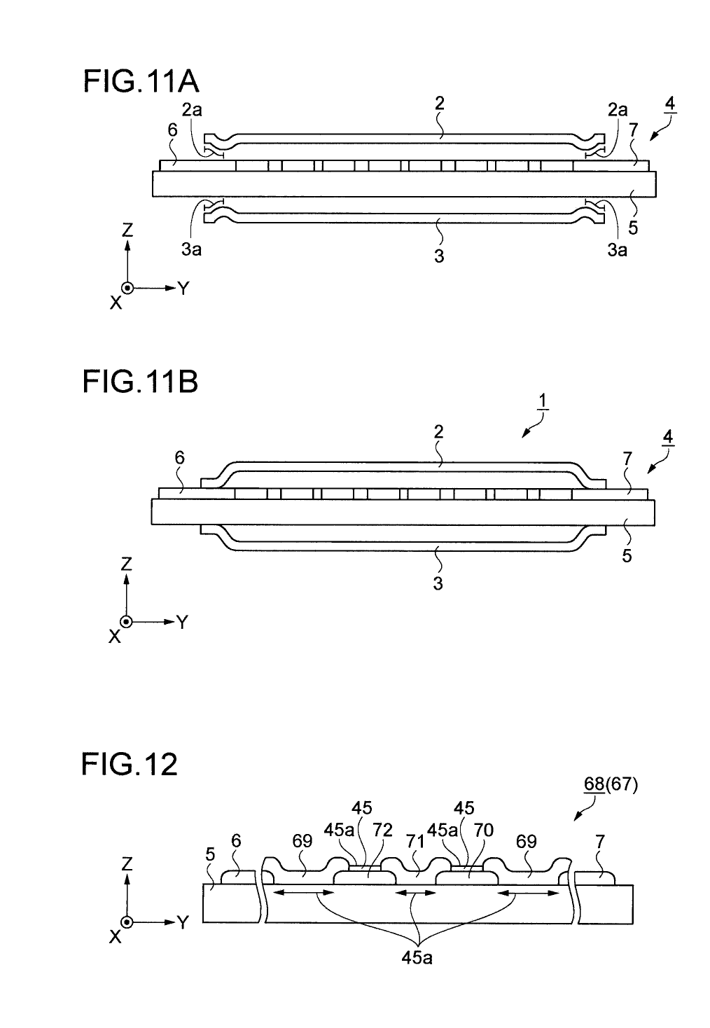

FIGS. 11A and 11B illustrate step S9 as the outer casing arranging step. As shown in FIG. 11A, at step S9, the upper outer casing 2 and the lower outer casing 3 are arranged so as to surround the battery substrate 4. Opposite ends of the upper and the lower outer casings 2 and 3 in the X direction are connected to each other in advance to form a tubular structure. Then, the battery substrate 4 is inserted into the structure formed by the upper and the lower outer casings 2 and 3. In this case, parts of the negative and the positive current collector films 6 and 7 are arranged so as to be protruded from the structure of the casings 2 and 3. Next, an adhesive is applied to end portions 2a of the opposite ends of the upper outer casing 2 in the Y direction and end portions 3a of the opposite ends of the lower outer casing 3 in the Y direction. Then, the upper and the lower outer casings 2 and 3 with the adhesive-applied end portions are each pressed against the substrate 5, and the adhesive is solidified to tightly seal the substrate 5 covered with the upper and the lower outer casings 2 and 3. Thereby, the battery 1 is completed as shown in FIG. 11B.

As described above, the present embodiment provides following advantageous effects.

1. In the embodiment, the substrate 5 includes the negative electrode current collector film 6, the positive electrode current collector film 7, the positive electrode electrolyte film 10, the intermediate electrolyte film 11, and the negative electrode electrolyte film 12 formed thereon. Movement of an electron and an ionized substance in the films allows charging and discharging. The plural films are arranged on the substrate, and the electron and the ionized substance move between the films. In this case, the movement of the electron and the ionized substance between the films can be facilitated by increasing a contact area between the films rather than reducing the area therebetween. Additionally, in order to increase the contact area between the films, it is more effective to arrange the films in such a manner that an end of one of adjacent films is overlapped with an end of the other one of the adjacent films, rather than allowing the ends of the adjacent films to contact with each other. Thus, overlapping between the ends of the adjacent films can facilitate movement of the electron and the ionized substance between the adjacent films.

2. In the embodiment, the negative electrode current collector film 6 and the negative electrode electrolyte film 12 adjacent to each other are partially overlapped with each other. The negative electrode current collector film 6 supplies or collects an electron to or from the negative electrode electrolyte film 12, thereby allowing electron movement between the films. In addition, the partial overlapping between the negative electrode current collector film 6 and the negative electrode electrolyte film 12 allows the contact area between the films 6 and 12 to be largely formed. This can facilitate electron movement between the films 6 and 12.

Similarly, since the positive electrode current collector film 7 is at least partially overlapped with the positive electrode electrolyte film 10, a contact area between the films 7 and 10 is largely formed, thereby facilitating electron movement between the films 7 and 10.

In addition, since the intermediate current collector film 9 is at least partially overlapped with the negative electrode electrolyte film 12, a contact area between the films 9 and 12 is also largely formed, so that electron movement between the films 9 and 12 can be facilitated.

Furthermore, since the intermediate current collector film 9 and the positive electrode electrolyte film 10 are at least partially overlapped with each other, a contact area between the films 9 and 10 can be largely formed, thereby enabling the electron to move more easily between the films 9 and 10.

3. In the embodiment, the electrolyte films of the electrolyte pattern 8 are overlapped on the current collector films including the negative electrode current collector film 6, the positive electrode current collector film 7, and the intermediate current collector film 9. Accordingly, the method of the embodiment is designed such that the electrolyte films of the electrolyte pattern 8 can be readily formed after formation of the current collector films. A current collector film is made of a highly conductive material and thus is often made of metal. In this case, metal microparticles are applied and then burned to form the current collector films. Thus, if the current collector films are formed after arranging the electrolyte films, heat due to burning of the current collector material can cause damage to the electrolyte films. However, in the method of the embodiment, the current collector films can be formed before formation of the electrolyte films, so that damage to the electrolyte films can be avoided.

4. In the embodiment, the an end of the positive electrode electrolyte film 10 is overlapped with the an end of the intermediate electrolyte film 11, and the an end of the negative electrode electrolyte film 12 is overlapped with the other end of the intermediate electrolyte film 11. The electrolyte films allow movement of an ionized substance. Since the ends of the electrolyte films are overlapped with each other, a contact area between the electrolyte films is largely formed, thereby facilitating movement of the ionized substance between the electrolyte films adjacent to each other.

5. In the embodiment, step S11 as the current collector arranging step arranges the current collector films, namely, the negative electrode current collector film 6, the positive electrode current collector film 7, and the intermediate current collector film 9. Then, the electrolyte films of the electrolyte pattern 8 are formed at step S12 as the intermediate electrolyte arranging step and step S13 as the positive and negative electrolytes arranging step. Since the current collector films are formed before the formation of the electrolyte films, the electrolyte films are not damaged by heat due to burning of the current collector material.

6. In the embodiment, after the lyophobic surface 45a is arranged, the function liquid 33 (33a to 33d) including the respective film materials is applied on the regions surrounded by the lyophobic surface 45a. Accordingly, high-precision formation of the position and the shape of the lyophobic surface 45a can lead to high-precision formation of the positions and the shapes of the current collector films 6, 7, and 9 and the electrolyte films 10, 11, and 12.

### Second Embodiment

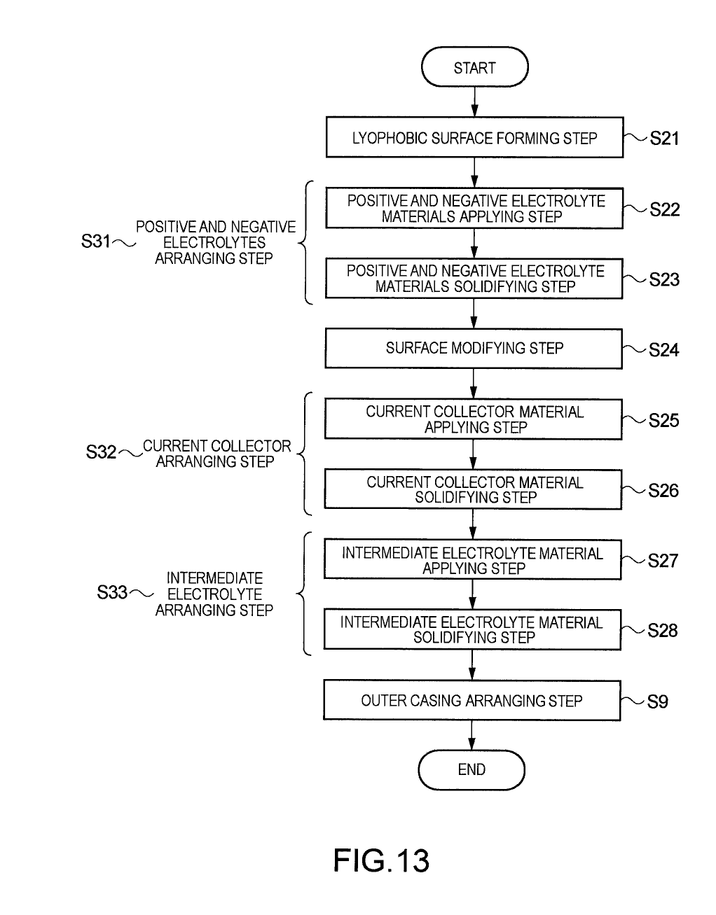

Next, with reference to FIGS. 12 and 13, a description will be given of a battery and a battery production method according to a second embodiment of the invention. FIG. 12 is a sectional view of a main section of a battery substrate. FIG. 13 is a flowchart showing steps of producing the battery of the second embodiment. The second embodiment is different from the first embodiment in that an end of each of films adjacent to each of a positive electrode electrolyte film and a negative electrode electrolyte film is overlapped on the each of the positive and the negative electrode electrolyte films. In the second embodiment, descriptions of same parts as those in the first embodiment will be omitted.

Specifically, in the second embodiment, as shown in FIG. 12, a battery substrate 68 of a battery 67 includes the substrate 5. On the substrate 5 is arranged an intermediate current collector film 69 as a film and a current collector film. In addition, the substrate 5 includes a positive electrode electrolyte film 70, an intermediate electrolyte film 71, and a negative electrode electrolyte film 72, each as a film and an electrolyte film. The intermediate current collector film 69 is arranged adjacent to the positive electrode electrolyte film 70 in such a manner that a part of the intermediate current collector film 69 is overlapped on the positive electrode electrolyte film 70. The positive electrode electrolyte film 70 is arranged adjacent to the intermediate electrolyte film 71 in such a manner that a part of the intermediate electrolyte film 71 is overlapped on the positive electrode electrolyte film 70. The intermediate electrolyte film 71 is arranged adjacent to the negative electrode electrolyte film 72 in such a manner that an other part of the intermediate electrolyte film 71 is overlapped on the negative electrode electrolyte film 72. Furthermore, the negative electrode electrolyte film 72 is arranged adjacent to the intermediate current collector film 69 in such a manner that an other part of the intermediate current collector film 69 is overlapped on the negative electrode electrolyte film 72.

Next, a method for producing the battery 67 will be described by referring to FIGS. 12 and 13. Step S21 corresponds to a lyophobic surface forming step. At this step, the lyophobic surface 45a is formed on the substrate 5. Specifically, the lyophobic surface 45a is formed so as to surround places intended to arrange the positive electrode electrolyte film 70 and the negative electrode electrolyte film 72. A method for forming the lyophobic surface 45a is the same as the method in the first embodiment and a description of the method will be omitted. Next will be step S22. Step S22 corresponds to a positive and negative electrolyte materials applying step. At this step, the fourth function liquid 33d including the material of the positive electrode electrolyte film is applied on the substrate 5. In addition, the third function liquid 33c including the material of the negative electrode electrolyte film is applied on the substrate 5, which is followed by drying of the third and the fourth function liquids 33c and 33d applied. Methods for applying and drying the third and the fourth function liquids 33c and 33d are the same as those in the first embodiment and descriptions thereof will be omitted. Then, step S23 will be performed. Step S23 corresponds to a positive and negative electrolyte materials solidifying step that polymerizes the electrolytic polymers included in the third and the fourth function liquids 33c and 33d applied. Steps S22 and S23 are included in step S31 as a positive and negative electrolytes arranging step that arranges the positive and the negative electrolyte films. Next will be step S24.

Step S24 corresponds to a surface modifying step. The surface modifying step eliminates the lyophobic property of the lyophobic surface 45a formed at step S21 and forms the lyophobic surface 45a on each of the positive electrode electrolyte film 70 and the negative electrode electrolyte film 72. Methods for eliminating the lyophobic property of the lyophobic surface 45a and forming the lyophobic surface 45a are the same as those in the first embodiment and descriptions thereof will be omitted. Next will be step S25, which corresponds to a current collector material applying step that applies and dries the first function liquid 33a including the material of the current collector film. In this case, the first function liquid 33a is applied from partial regions on the positive and the negative electrode electrolyte films 70 and 72 onto the substrate 5. A method for applying the first function liquid 33a is the same as that in the first embodiment and a description thereof will be omitted. Then, step S26 will be performed. Step S26 corresponds to a current collector material solidifying step that burns the first function liquid 33a of the applied current collector material to solidify the material liquid. A part of the intermediate current collector film 69 is formed so as to overlap on each of the positive and the negative electrolyte films 70 and 72. Similarly, a part of the negative electrode current collector film 6 is overlapped on the negative electrode electrolyte film 72, and a part of the positive electrode current collector film 7 is overlapped on the positive electrode electrolyte film 70. A burning method is the same as that in the first embodiment and a description thereof will be omitted. Steps S25 and S26 are included in step S32 as a current collector arranging step that arranges each of the current collector films. Next will be step S27.

Step S27 corresponds to an intermediate electrolyte material applying step. At this step, the second function liquid 33b including a material of the intermediate electrolyte film 71 is applied and dried. In this case, the second function liquid 33b is applied from a partial region on each of the positive and the negative electrode electrolyte films 70 and 72 onto the substrate 5. Methods for applying and drying the second function liquid 33b are the same as those in the first embodiment and descriptions thereof will be omitted. Then, step S28 will be performed. Step S28 corresponds to an intermediate electrolyte material solidifying step that polymerizes an electrolyte polymer included in the applied second function liquid 33b. A part of the intermediate electrolyte film 71 is formed so as to overlap on each of the positive and the negative electrolyte films 70 and 72. Steps S27 and S28 are included in step S33 as an intermediate electrolyte arranging step that arranges the intermediate electrolyte film 71. Then, step S31 as the positive and negative electrolytes arranging step and step S33 as the intermediate electrolyte arranging step are included in an electrolyte arranging step. Step S9 corresponds to an outer casing arranging step that arranges the outer casing components. Thus, the battery production process ends through the steps.

As described above, the present embodiment provides following advantageous effects.

1. In the embodiment, on the substrate 5 are arranged the negative electrode current collector film 6, the positive electrode current collector film 7, the intermediate current collector film 69, the positive electrode electrolyte film 70, the intermediate electrolyte film 71, and the negative electrode electrolyte film 72. Among those films, ends of adjacent films are overlapped with each other. This can facilitate movement of an electron and an ionized substance between the films adjacent to each other.

2. In the embodiment, the lyophobic surface 45a is formed so as to surround the places of the films before forming the films, whereby the films can be formed with high precision.

3. In the embodiment, the negative electrode current collector film 6 and the positive electrode current collector film 7 are formed only on the substrate 5, so that the shapes and the film thicknesses can be formed with high precision.

### Third Embodiment

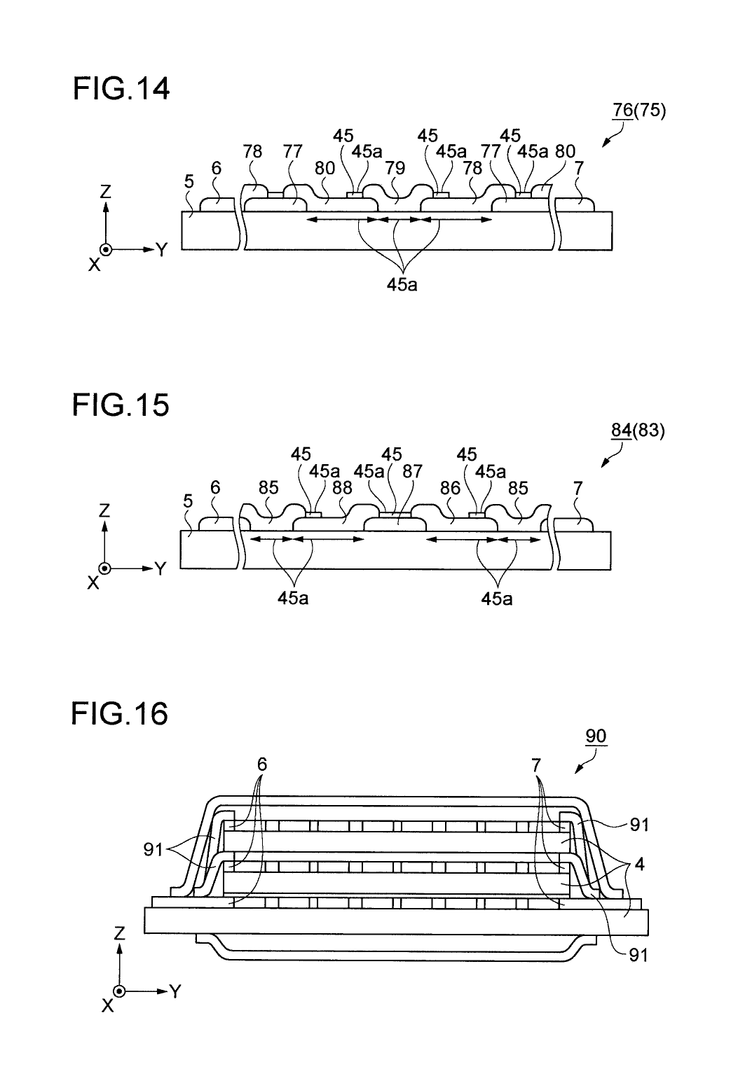

Next, a battery according to a third embodiment will be described by referring to FIG. 14. FIG. 14 is a sectional view showing a main section of a battery substrate. The third embodiment is different from the first embodiment in that each end of an intermediate electrolyte film is overlapped on each of a positive electrolyte film and a negative electrolyte film. In the third embodiment, descriptions of same parts as those in the first embodiment will be omitted.

Specifically, in the present embodiment, as shown in FIG. 14, a battery substrate 76 of a battery 75 includes the substrate 5. On the substrate 5 are arranged an intermediate current collector film 77 as a film and a current collector film, a positive electrode electrolyte film 78, an intermediate electrolyte film 79, and a negative electrode electrolyte film 80, each as a film and an electrolyte film. The intermediate current collector film 77 is arranged adjacent to the positive electrode electrolyte film 78 in such a manner that a part of the positive electrode electrolyte film 78 is overlapped on the intermediate current collector film 77. The positive electrode electrolyte film 78 is arranged adjacent to the intermediate electrolyte film 79 in such a manner that a part of the intermediate electrolyte film 79 is overlapped on the positive electrode electrolyte film 78. The intermediate electrolyte film 79 is arranged adjacent to the negative electrode electrolyte film 80 in such manner that a part of the intermediate electrolyte film 79 is overlapped on the negative electrode electrolyte film 80. In addition, the negative electrode electrolyte film 80 is arranged adjacent to the intermediate current collector film 77 in such a manner that a part of the negative electrode electrolyte film 80 is overlapped on the intermediate current collector film 77.

Next will be described an outline of a method for forming the battery substrate 76. First, the lyophobic surface 45a is arranged around places intended to arrange the negative electrode current collector film 6, the positive electrode current collector film 7, and the intermediate current collector film 77. Thereafter, the current collector films 6, 7, and 77 are arranged, which is followed by elimination of the lyophobic surface 45a arranged in places intended to arrange the positive and the negative electrode electrolyte films 78 and 80. Then, after arrangement of the positive and the negative electrode electrolyte films 78 and 80, the lyophobic surface 45a is arranged on each of the electrolyte films 78 and 80. Next, the intermediate electrolyte film 79 is arranged, thereby completing production of the battery substrate 76. The structure of the present embodiment can provide the same advantageous effects as those of Nos. 1 to 6 described in the first embodiment.

### Fourth Embodiment

Next, a battery according to a fourth embodiment will be described by referring to FIG. 15. FIG. 15 is a sectional view of a main section of a battery substrate. The fourth embodiment is different from the first embodiment in that each end of an intermediate current collector film is overlapped on each of a positive electrode electrolyte film and a negative electrode electrolyte film. In the fourth embodiment, descriptions of same parts as those in the first embodiment will be omitted.

Specifically, in the present embodiment, as shown in FIG. 15, a battery substrate 84 of a battery 83 includes the substrate 5. On the substrate 5 are arranged an intermediate current collector film 85 as a film and a current collector film, a positive electrode electrolyte film 86, an intermediate electrolyte film 87, and a negative electrode electrolyte film 88, each as a film and an electrolyte film. The intermediate current collector film 85 is arranged adjacent to the positive electrode electrolyte film 86 in such manner that a part of intermediate current collector film 85 is overlapped on the positive electrode electrolyte film 86. The positive electrode electrolyte film 86 is arranged adjacent to the intermediate electrolyte film 87 in such a manner that a part of the positive electrode electrolyte film 86 is overlapped on the intermediate electrolyte film 87. The intermediate electrolyte film 87 is arranged adjacent to the negative electrode electrolyte film 88 in such a manner that a part of the negative electrode electrolyte film 88 is overlapped on the intermediate electrolyte film 87. In addition, the negative electrode electrolyte film 88 is arranged adjacent to the intermediate current collector film 85 in such a manner that a part of the intermediate current collector film 85 is overlapped on the negative electrode electrolyte film 88.

Next will be described an outline of a method for forming the battery substrate 84. First, the lyophobic surface 45a is arranged around a place intended to arrange the intermediate electrolyte film 87. Then, the intermediate electrolyte film 87 is arranged, and next, the lyophobic surface 45a arranged in places intended to arrange the positive and the negative electrode electrolyte films 86 and 88 is eliminated. After arrangement of the positive and the negative electrode electrolyte films 86 and 88, the lyophobic surface 45a is arranged on each of the electrolyte films 86 and 88, which is followed by elimination of the lyophobic surface 45a arranged in places intended to arrange the negative current collector film 6, the positive current collector film 7, and the intermediate current collector film 85. Then, the current collector films 6, 7, and 85 are arranged, thereby completing formation of the battery substrate 84. The structure of the present embodiment can provide the same advantageous effects as those of Nos. 1, 2, 4, and 6 described in the first embodiment.

The embodiments of the invention are not restricted to those described above and various modifications and alterations may be added. Hereinafter, modifications will be described.

### First Modification

In the first embodiment, the battery 1 includes a single battery substrate 4. However, the battery may include a plurality of battery substrates. FIG. 16 is a sectional view of a battery 90. For example, as in the battery 90 of FIG. 16, three battery substrates 4 may be placed one on top of another. Then, the negative electrode current collector films 6 of the respective batter substrates 4 are connected to one another by using a wire 91, and the positive electrode current collector films 7 are connected to one another by using an other wire 91. In this manner, the battery substrates 4 are connected parallel to one another, whereby the battery 90 can provide a large amount of current output. A quantity of pieces of the battery substrates 4 is not restricted. For example, two or four pieces or more of the battery substrates 4 may be used. The content described above can also be applied to the second to the fourth embodiments.

### Second Modification

In the first embodiment, the lyophobic surface 45a is formed on the substrate 5. However, alternatively, a partition wall may be provided that has a same shape as the pattern of the lyophobic surface 45a, thereby preventing the function liquid 33 from flowing onto the lyophobic surface 45a. This can increase an amount of the function liquid 33 applied each time.

### Third Modification

In the first embodiment, the lyophobic film 45 is formed using the microcontact printing method. However, other methods can be employed. For example, a plasma treatment using a fluorine compound-containing gas as a treatment gas may be performed. Using a fluorine compound allows a fluorine group to be introduced onto a surface of the substrate 5, thereby making the surface lyophobic to liquid materials. Examples of the fluorine compound include CF₄, SF₆, and CHF₃.

### Fourth Modification

Although the first embodiment uses the piezoelectric element 35 as a pressurizing means pressurizing the cavity 32, other methods can be employed. For example, the vibrating plate 34 may be deformed by using a coil and a magnet to pressurize the cavity 32, or a heater wire may be arranged in the cavity 32 to heat the heater wire so as to gasify the function liquid 33 or expand a gas included in the function liquid 33, thereby pressurizing the cavity 32. As another alternative method, the vibrating plate 34 may be deformed by using electrostatic attraction or repulsion to cause pressurization. The function liquid 33 can be applied in the same manner as in the embodiment.

### Fifth Modification

In the first embodiment, the positive electrode electrolyte film 10, the intermediate electrolyte film 11, and the negative electrode electrolyte film 12 are linearly arranged parallel to each other. However, this is merely an example of the arrangement of the films. For example, the positive electrode electrolyte film 10 and the negative electrode electrolyte film 12 may be arranged in a pattern where rectangular concave and convex portions are formed on planes to allow the concave and the convex portions to be engaged with each other. Shapes of the concave and the convex portions are not restricted to such a rectangular one, and the portions may have another shape, such as a waveform-like shape, a triangle shape, or a polygonal shape. The portions may be formed into a linear or acyclic pattern. The content described above can also be applied to the second to the fourth embodiments.

### Sixth Modification

The first embodiment performs, only once, the application and the solidification of the function liquid 33 including the material of each of the positive electrode electrolyte film 10, the intermediate electrolyte film 11, and the negative electrode electrolyte film 12, the negative electrode current collector film 6, the positive electrode current collector film 7, and the intermediate current collector film 9. However, the application and the solidification thereof may be repeated a plurality of times. Application and drying of the function liquid 33 including the each film material may be performed a plurality of times to increase the film thickness, and then, the function liquid 33 may be solidified. The larger thickness each film has, the easier the movement of an electron and an ionized substance becomes, thereby improving performance of the battery 1. The content described above can also be applied to the second to the fourth embodiments.

### Seventh Modification

In the first embodiment, at step S7 as the positive and negative electrolyte materials applying step, the fourth function liquid 33d including the material of the positive electrode electrolyte film 10 is applied after application of the third function liquid 33c including the material of the negative electrolyte film 12. However, the order of application of the function liquids may be reversed to form the same films.

### Eighth Modification

In the first embodiment, at step S5 as the intermediate electrolyte solidifying step, the intermediate electrolyte film 11 is polymerized, and at step S8 as the positive and negative electrolyte materials solidifying step, the positive electrode electrolyte film 10 and the negative electrode electrolyte film 12 are polymerized. However, instead of that, at step S4 as the intermediate electrolyte material applying step, when the second function liquid 33b including the material of the intermediate electrolyte film 11 is dried to be solidified, step S5 may be omitted. Then, at step S8, the intermediate electrolyte film 11 may be polymerized. Thereby, the number of the steps can be reduced, thus increasing production efficiency of the battery 1. The content described above can also be applied to the second to the fourth embodiments.

### Ninth Modification

In the first embodiment, the films are arranged on the substrate 5 to form the battery substrate 4. Instead of the substrate 5, the films may be arranged on a surface of a rectangular parallelepiped member or the like. The battery may be formed by utilizing a surface of various kinds of structures. This enables the surface of various structures to be effectively utilized.

### Tenth Modification

The second embodiment performs step S33 as the intermediate electrolyte arranging step after step S32 as the current collector arranging step. However, conversely, step S32 may be performed after step S33. In this case, similarly, the intermediate current collector film 69 and the intermediate electrolyte film 71 can be arranged.

### Eleventh Modification

In the first embodiment, the intermediate electrolyte film 11 does not include an electrolytic solution. However, the intermediate electrolyte film 1 may be formed into an electrolytic solution-containing layer. For example, the electrolytic solution may be applied after applying the material of the intermediate electrolyte film 11 at step S4 as the intermediate electrolyte material applying step. Alternatively, after forming the intermediate electrolyte film 11 at step S5 as the intermediate electrolyte material solidifying step, the electrolytic solution may be applied. Thereby, the intermediate electrolyte film 11 becomes a gel electrolyte, so that transmission of an ionized substance can be facilitated. The content described above can also be applied to the second to the fourth embodiments.

What is claimed is:

1. A battery, comprising:
a base member; and
a plurality of films arranged adjacent to each other on a same surface of the base member, at least a part of one of the films is overlapped with an adjacent one of the films.

2. The battery according to claim 1, wherein the films include a current collector film and an electrolyte film, the current collector film being arranged adjacent to the electrolyte film in such a manner that at least a part of one of the current collector film and the electrolyte film adjacent to each other is overlapped with at least a part of an other one of the adjacent films.

3. The battery according to claim 2, wherein the electrolyte film is overlapped on the current collector film.

4. The battery according to claim 3, wherein the electrolyte film is a positive electrode electrolyte film including a positive electrode active material.

5. The battery according to claim 3, wherein the electrolyte film is a negative electrode electrolyte film including a negative electrode active material.

6. The battery according to claim 1, wherein the films include a plurality of electrolyte films, at least a pair of the electrolyte films being arranged adjacent to each other in such a manner that at least a part of one of the adjacent electrolyte films is overlapped with at least a part of an other one of the adjacent electrolyte films.

7. The battery according to claim 6, wherein the electrolyte films include a positive electrode electrolyte film including a positive electrode active material and an intermediate electrolyte film including no active material, the positive electrode electrolyte film being arranged adjacent to the intermediate electrolyte film in such a manner that at least a part of the positive electrode electrolyte film is overlapped with at least a part of the intermediate electrolyte film.

8. The battery according to claim 6, wherein the electrolyte films include a negative electrode electrolyte film including a negative electrode active material and an intermediate electrolyte film including no active material, the negative electrode electrolyte film being arranged adjacent to the intermediate electrolyte film in such a manner that at least a part of the negative electrode electrolyte film is overlapped with at least a part of the intermediate electrolyte film.

9. A method for producing a battery, comprising:
arranging a current collector film on a surface of a base member; and
arranging an electrolyte film on the surface of the base member, the electrolyte film being arranged after arranging the current collector film so as to be adjacent to the current collector film in such a manner that at least a part of the current collector film is overlapped with at least a part of the electrolyte film.
